(19) United States
(12) Patent Application Publication
(10) Pub. No.: US 2011/0289837 A1
(43) Pub. Date: Dec. 1, 2011

(54) Inverted Planter With Support

(76) Inventors: William J. Phillips, Batavia, IL (US); Michael R. Vogler, Oswego, IL (US)

(21) Appl. No.: 12/788,523

(22) Filed: May 27, 2010

(51) Int. Cl. A01G 9/02

(52) U.S. Cl. 47/65.6; 47/65.5

(57) ABSTRACT

The instant invention describes a portable and reusable gardening device and kit for providing growth of one or more plant varieties in a downward manner while simultaneously providing for plant growth in an upward direction. The device comprises a planter bed for holding one or more plants. The planter bed includes an outer wall defined by a front panel, a back panel, a right side panel, and a left side panel. The panels are constructed and arranged to partially enclose a bottom panel. Each of the side panels extend upwardly from the bottom panel. The bottom panel has at least one aperture for receipt of a plant root or stems system, and preferably, has one main center aperture and a plurality of side apertures. The portable and reusable gardening device further includes a support base having integrally formed side walls which extend in a downward manner from a first generally planer surface. The side walls are constructed and arranged to enclose an integrally formed inner cavity for receiving stabilizing materials. The integrally formed inner cavity is constructed and arranged to cooperate with a support base internal cavity cover. A second surface forms a perimeter around the first surface. A plurality of planter bed support legs are provided for support and height. The plurality of planter bed support legs have a first end constructed and arranged to be secured to and extend below the planter bed and a second end constructed and arranged to be secured to and extend above the support base. Covering the main center aperture, the plurality of side apertures, and the internal cavity of the support base are the main center aperture cover, a plurality of side aperture covers, and an internal cavity cover, respectively.

### RELATED APPLICATIONS

This application is related to U.S. application No. 29/352,204; filed Dec. 17, 2009, entitled “Inverted Planter with Support Structure,” which is incorporated herein by reference.

### FIELD OF THE INVENTION

The present invention relates to a gardening device; more particularly to a stable, elevated gardening device that provides for growing a variety of plants, including vegetables and flowering plants, in an upward and/or downward direction.

### BACKGROUND OF THE INVENTION

Gardening and gardening services are huge businesses in the United Sates as well as internationally. In 2008, Americans spent a total of $2.8 billion to buy seeds, plants, fertilizer, and other gardening supplies and services. Various reasons contribute to the popularity of home gardening. One of the most obvious reasons is that planting plants is aesthetically pleasing, adding beauty and warmth to a home or backyard. A properly constructed garden and landscaping can add significant value to a person's home and may even help reduce electricity related costs.

In addition to aesthetic qualities, individuals have begun to recognize other benefits of planting, particularly the growing of vegetables out of their own gardens. Over growing concerns of commercially contaminated food sources, consumers see growing their own food as a means to control safety concerns of the food they are eating. As consumers realize that growing their own food can result in improvements to food quality and taste, and cost savings as a result of lower food bills, the number of households participating in home gardening and planting is expected to rise. While planting and gardening is generally not a problem for homeowners with large plots of land, those who live on zero-lot plots or in crowded cities are not capable of planting in large, open fields, and are thus limited in their planting options.

Despite these limitations, the desire to plant under these conditions is not less than those who have large spaces for planting. Of vital importance to these living conditions is the ability to plant large varieties of plants and vegetables within limited amounts of space, and requires alternative approaches to gardening. One such approach is the use of gardening containers. As evidenced by a trip to any local home improvement or gardening establishment, there exists numerous planting container options. Many of these containers, however, are limiting. Small planters may not be as desirable because they are limiting in size and often are not very stable. Given the small size, these planters are not conducive to watering and maintenance as they are usually placed at ground level or must be secured to a fence or bench if a certain height relative to the ground is desired. While a greater number of plants can be used with large pots, the size and amount of soil required to establish healthy plants can be a limiting factor for those in tight spaces. As such, there is always a need for containers that allow for maximization of plant growth within confined spaces.

### DESCRIPTION OF THE PRIOR ART

U.S. Pat. No. 4,268,994 discloses a three-dimensional decorative planter having a frame for securing a vertically disposed cultivation body. The planter has a liquid reservoir and conduit for movement of liquid from the reservoir to the cultivation body. The frame also has a trough for collecting excess liquid. The cultivation body includes culture material and filler in arrangements necessary to secure the culture material and provide watering, drainage and ventilation.

U.S. Pat. No. 5,333,409 discloses a hanging pot containing a plurality of tubular inserts which extend through the outer wall of the pot. The hanging pot is constructed such that the root portion of the growing plants are planted within the pot and the stalks of growing plants are extended through the tubular inserts so that they hang downwardly from the pot. The tubular inserts surround the stalks or stems of the plants and protect them from breaking under their own weight as they hang downwardly.

U.S. Pat. No. 5,450,691 discloses a support for plants and flowers, and includes a framework surrounding an upstanding central tube. The framework consists of a plurality of vertically spaced, circular rings which decrease in diameter from bottom to top. Vertical supports span adjacent rings and are spaced about the circumference of the framework. A retaining ring surrounds the bottom of the tube adjacent its bottom and has two pair of diametrically extending arms with down-turned ends to support the tube in an upright manner. A second retaining ring surrounds the tube adjacent the top of the framework. The down-turned ends of this retaining ring snap over the top of the framework to hold the framework and tube in place. Matting lines the interior of the framework to define an area within the framework which is filled with soil. Plants and flowers, therefore, can be planted in the soil through the matting. The framework can be placed in an existing flower pot or can stand alone. Accessories of various shapes, such as a sphere, can be attached to the top of the tube above the framework to increase the variety of arrangements that can be created.

U.S. Pat. No. 5,577,344 discloses a portable party riser, or pedestal-type stand. The party riser consists of several container-bases and a thin cylindrical rigid stem for support. The container-bases are manually connected to this stem by fitting either of the two ends of the support tightly into the appropriate socket or hub on either surface of the flange of each container-base. The structure is generally supported by a bottom container acting as the base, and resting upon a horizontal surface such as a floor or table top.

U.S. Pat. No. 5,617,673 discloses a gravity independent photosynthetic growing system for use in providing an environment conducive to growing plant materials under unusual conditions, such as are encountered in space or in locations isolated from sunlight. The growing system includes a stationary core assembly, a rotating drum assembly which is rotated by a motive assembly, an enclosing assembly, a growth requirements assembly and a control assembly. Illumination lamps situated in the central core provide photosynthetic radiation which is transmitted through light transmissive sector walls to be reflected inward from a surrounding cylindrical reflector into growth sectors within which the plants are grown. The growth sectors are adapted to receive seed mats, hard shell growth cases and growth bags which provide purchase for the plants. A deluxe growth requirements assembly provides controlled dispensation of flowable materials by way of pneumatically controlled flow paths. The system is adapted to further provide temperature and moisture to non-photosynthetic plants in dark zones within the stationary enclosure.

U.S. Pat. No. 6,094,861 discloses a method and device for the growing of tomatoes and other vegetables out from the bottom of a container suspended above ground, thereby eliminating the conventional problems routinely associated with home gardening. In particular, the device allows gardening in a space efficient manner without having to routinely weed and water the plant soil. A drip well in the top of the container provides a constant source of moisture. Suspension of the container above ground eliminates the threat of ground borne insects and small animal pests without the use of pesticides and repellents.

U.S. Pat. No. 6,269,588 discloses a flower pot for group planting of flower plants which is mounted on a pole. The flower pot comprises a flower pot body having planting openings of which the upper part is opened. The planting openings are provided in a plurality of locations in the periphery of the body. The flower pot contains a hole in the bottom of the body for inserting the pole and a cylindrical mounting member for inserting the upper part of the pole. The bottom of the mounting member is opened and the mounting member is fixedly or removably mounted vertically around the hole. The outer face of the flower pot is covered by the group planted flower plants and not exposed when the flower pot in which flower plants have been group planted is mounted on the pole.

U.S. Pat. No. 6,298,600 discloses a suspended planting container. The container includes a base having an outer periphery and an aperture defining a central vegetation region. An outer wall extends upward from the periphery of the base to a top edge and defines a container region. An inner wall, surrounding the central vegetation region extends upward from the base to a top edge in the interior of the container region. A growing medium retention device is coupled to the top edge of the inner wall to permit vegetation to grow through the perforation into the central vegetation region while prevent growing medium from falling from the container region into the vegetation region.

U.S. Pat. No. 6,381,900 describes a hanging planter which includes a bowl-like lower portion and a ring-like upper portion, with the upper portion nesting within the rim of the lower portion to provide a plant holding assembly. The upper edge of the lower portion and lower edge of the upper portion are crenelated, with the mating edges defining a series of plant growth openings there through when the two components are assembled. The crenelations are preferably of variable depths in each section, to define at least two different levels of plant growth openings through the sides of the assembly. The upper edge of the upper portion defines a third plant growth opening for the device. The planter is suspended by a single central hanger rod which secures through the bottom of the lower portion of the container and provides a leakproof seal. A fertilizer wick is placed upon the central rod, with the wick serving to deliver fertilizer to the generally centrally disposed roots of the plants, and also to wick up water from the lower portion of the planter to the plant roots.

U.S. Pat. No. 6,843,022 describes an apparatus having a central support conduit with a hollow fluid passageway. A plurality of downwardly arching arms extends radially outward from the central support conduit for carrying a plant container. A mounting sleeve is carried on the central support conduit that includes a plurality of arm brackets for carrying the arms. A fluid distribution hub is carried by the central support conduit and has a chamber in fluid communication with the hollow fluid passageway, and a plurality of fluid diversion conduits extending radially outward from the chamber. A plurality of watering lines, each carrying a valve to control fluid flow through the lines, extend radially outward from the fluid distribution hub. Each watering line has a source end in fluid communication with one of the fluid diversion conduits, and a nozzle end disposed near a distal end of one of the arms for channeling fluid into the plant container.

U.S. Pat. No. 6,874,278 describes a planter for growing a transplanted plant upside down. The planter has a container having an interior, a bottom and a hole defined within the bottom. The planter further utilizes a retainer member which is attachable to the plant desired to be transplanted within the planter. The retainer member cooperates with the container for supporting the plant through the hole defined within the container bottom so that the root system is exposed to the interior of the container and so that the plant stem extends downwardly from the bottom of the container.

While the cited prior art teaches a variety of containers and devices that provide for the growth of plants and vegetables in either the upward or downward direction, few of these inventions teach a container that provides growth in both directions. U.S. Pat. No. 6,345,466 describes a method of planting utilizing a gardening system comprising an assembled center support, large base, small base and a grow box with a plurality of holes in the bottom. The system can be utilized for growing multiple types of vegetation upside down out of the bottom of the grow box. In addition, plants and vegetation can be grown upright, as well as, out of the open top of the grow box. However, the planter box used in the claimed method is limited in its structure. The planter box, as described, is limited to a single post positioned into the center in order to support the upper grow box. A disadvantage in this design is that the device can become top heavy, thereby limiting the number, types and placement of plant growth permitted in order to prevent tipping over and bowing of the container parts.

Therefore, what is needed in the art is a portable, easy to assemble elevated gardening device which provides for plant growth in the upward and/or downward direction, and which is stable regardless of the plant varieties placed within the planter bed.

### SUMMARY OF THE INVENTION

The instant invention describes a portable, reusable and easy to assemble elevated gardening device which is designed to allow growth of a variety of plant species. As used herein, “plant species” or “plant” is defined as any variety of living organisms belonging to the Kingdom Plantae, including but not limited to trees, shrubs, herbs, grasses, and plants that produce flowers, fruits, vegetables, pods, nuts, ears, cones, or the like. The instant invention provides a device that allows the growth of plant species on patios, balconies, and various outside living areas of a home where traditional gardening space is either limited or not available. In order to maximize the limited space, the elevated gardening device provides certain types of growth, i.e. tomatoes or cucumbers, in an upside down position from the underside of the planter bed through one or more apertures, simultaneously as other plant varieties are planted in the planter bed and permitted to grow in an upward direction.

In a particular embodiment, the instant invention describes a portable and reusable gardening device and kit for providing growth of one or more plant varieties in a downward manner while simultaneously providing for plant growth in an upward direction. The device comprises a planter bed for holding one or more plants. The planter bed includes an outer wall defined by a front panel, a back panel, a right side panel, and a left side panel. The panels are constructed and arranged to partially enclose a bottom panel. Each of the side panels extend upwardly from the bottom panel. The bottom panel has at least one aperture for receipt of a plant root or stems system, and preferably, has one main center aperture and a plurality of side apertures. The portable and reusable gardening device further includes a support base having integrally formed side walls which extend in a downward manner from a first generally planer surface. The side walls are constructed and arranged to enclose an integrally formed inner cavity for receiving stabilizing materials. The integrally formed inner cavity is constructed and arranged to cooperate with a support base internal cavity cover. A second surface forms a perimeter around the first surface. A plurality of planter bed support legs are provided for support and height. The plurality of planter bed support legs have a first end constructed and arranged to be secured to and extend below the planter bed and a second end constructed and arranged to be secured to and extend above the support base. Covering the main center aperture, the plurality of side apertures, and the internal cavity of the support base are the main center aperture cover, a plurality of side aperture covers, and an internal cavity cover, respectively.

Accordingly, it is an objective of the instant invention to provide an elevated gardening device for holding a variety of plant species.

It is a further objective of the instant invention to provide an elevated gardening device that allows simultaneous growth of a variety of plant species in an upward direction and a downward direction.

It is yet another objective of the instant invention to provide an elevated gardening device which is manufactured in a plurality of parts for ease of storage.

It is a still further objective of the invention to provide an elevated gardening device which is manufactured in a plurality of parts for ease of transportation.

It is a further objective of the instant invention to provide an elevated gardening device which is manufactured in a plurality of parts for ease of assembly, and more particularly for ease of assembly without tools.

It is yet another objective of the instant invention to provide an elevated gardening device which is stable under static loading.

It is a still further objective of the invention to provide an elevated gardening device in which the individual components are easy to disassemble and can be nested for greater storage flexibility.

It is a further objective of the instant invention to provide an elevated gardening device constructed and arranged to contain a planter bed, a support base, and a plurality of support legs for connecting the support base to the planter bed.

It is yet another objective of the instant invention to provide an elevated gardening device in which the planter bed provides for the ability to grow plants, such as tomato plants, in a downward direction from the center of the planter bed, on four sides of the planter bed, or combinations thereof.

It is a still further objective of the invention to provide an elevated gardening device in which the planter bed contains a large planter aperture in the center in order to allow the transplantation of more mature plants within the elevated gardening device.

It is a further objective of the instant invention to provide an elevated gardening device in which the support base is constructed and arranged to contain an inner cavity which can be easily filled with stabilizing material in order to provide enhanced product stability.

It is yet another objective of the instant invention to provide an elevated gardening device in which the inner cavity of the support base can be easily emptied of support stabilizing material for seasonal storage.

It is a further objective of the instant invention to provide an elevated gardening device in which the planter bed contains plant root holder elements which are designed to secure the plant stem and/or root systems to the planter bed.

It is yet another objective of the instant invention to provide an elevated gardening device in which the planter bed can be manipulated to provide a more convenient and desired height for watering, planting, and maintenance.

It is a still further objective of the invention to provide an elevated gardening device which is aesthetically pleasing and decorative for placement in areas of high visibility.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a top right perspective view of the elevated gardening device of the instant invention;

FIG. 2 is a top rear perspective view of the elevated gardening device of the instant invention;

FIG. 3 is an exploded view of the elevated gardening device of the instant invention;

FIG. 4A is a cross sectional view of the elevated gardening device of the instant invention, illustrating press fit connections of the support legs, and support legs inserted into the planter bed and support base;

FIG. 4B is a cross sectional view of the support base of the elevated gardening device of the instant invention as illustrated in FIG. 4A;

FIG. 5A is a view of a particular embodiment of the top surface of the bottom panel of the planter bed of the elevated gardening device of the instant invention;

FIG. 5B illustrates a view of a particular embodiment of the bottom surface of the bottom panel of the planter bed of the elevated gardening device of the instant invention;

FIG. 6 illustrates the planter bed of the elevated gardening device of the instant invention with the front panel removed;

FIG. 7A illustrates a particular embodiment of the planter bed main cover of the elevated gardening device of the instant invention;

FIG. 7B illustrates a particular embodiment of the one or more planter bed side aperture cover of the elevated gardening device of the instant invention;

FIG. 8 is a perspective view of a particular embodiment of the support base of the elevated gardening device of the instant invention;

FIG. 9 is a bottom perspective view of the elevated gardening device of the instant invention;

FIG. 10 illustrates the insertion of stabilizing material within the internal cavity of the support base of the elevated gardening device of the instant invention;

FIG. 11 illustrates placement of the support base cover over the internal cavity of the elevated gardening device of the instant invention;

FIG. 12a is an exploded view of the main support leg of the elevated gardening device of the instant invention;

FIG. 12b illustrates a fully assembled main support leg of the elevated gardening device of the instant invention;

FIG. 13 is an illustration of the support legs being inserted within the support base of the elevated gardening device of the instant invention;

FIG. 14 is an illustration of the support legs being inserted within the planter bed of the elevated gardening device of the instant invention;

FIG. 15 illustrates insertion of the planter bed main cover and the one or more side covers into the center aperture of the planter bed and the one or more side apertures of the planter bed;

FIG. 16A is a bottom view of the bottom panel with the center aperture being covered by the center aperture cover, thus forming a drainage hole;

FIG. 16B is a top view of the bottom panel with a cover in position over the center aperture and illustrating a drainage hole;

FIG. 17A shows one of the apertures without a corresponding cover attached, illustrating a portion of a plant stem cut out section;

FIG. 17B illustrates one of the apertures with a corresponding cover attached and forming a plant stem cut out section.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

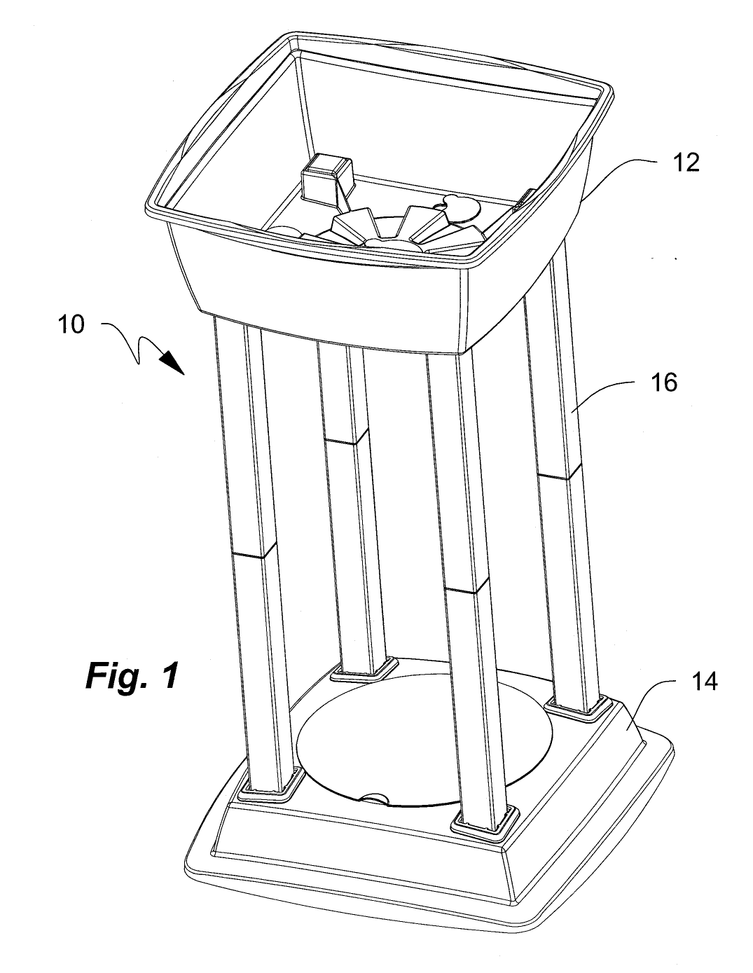

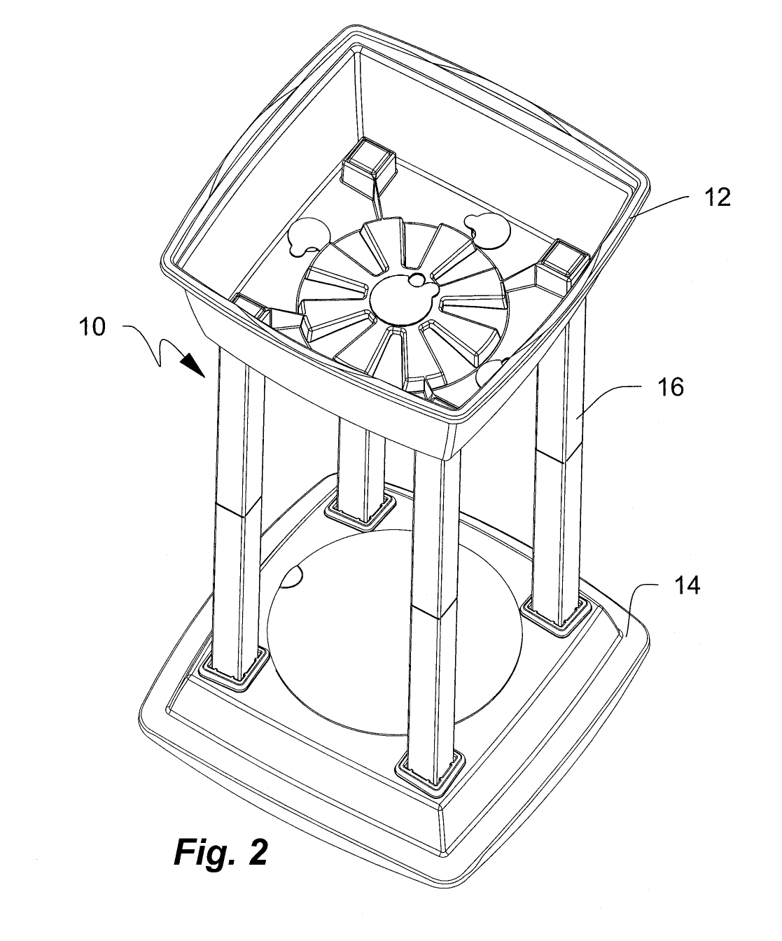

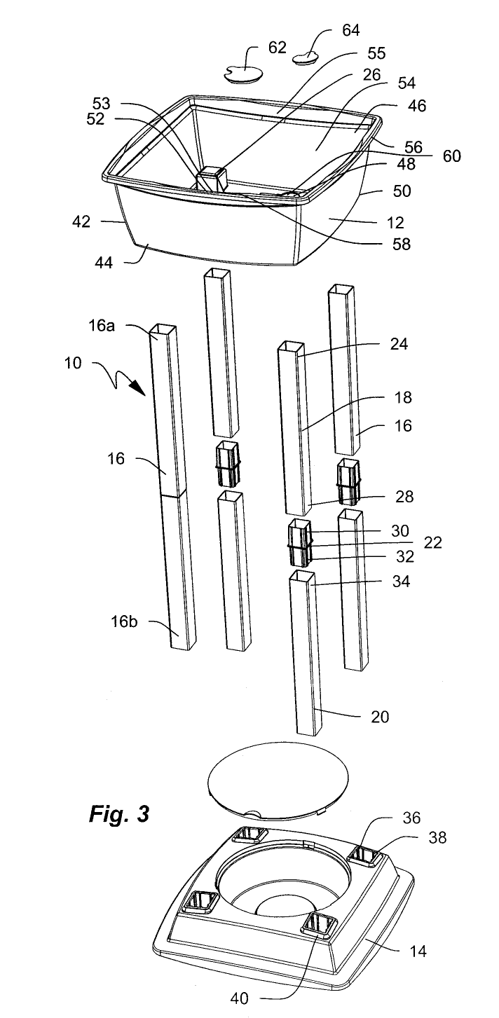

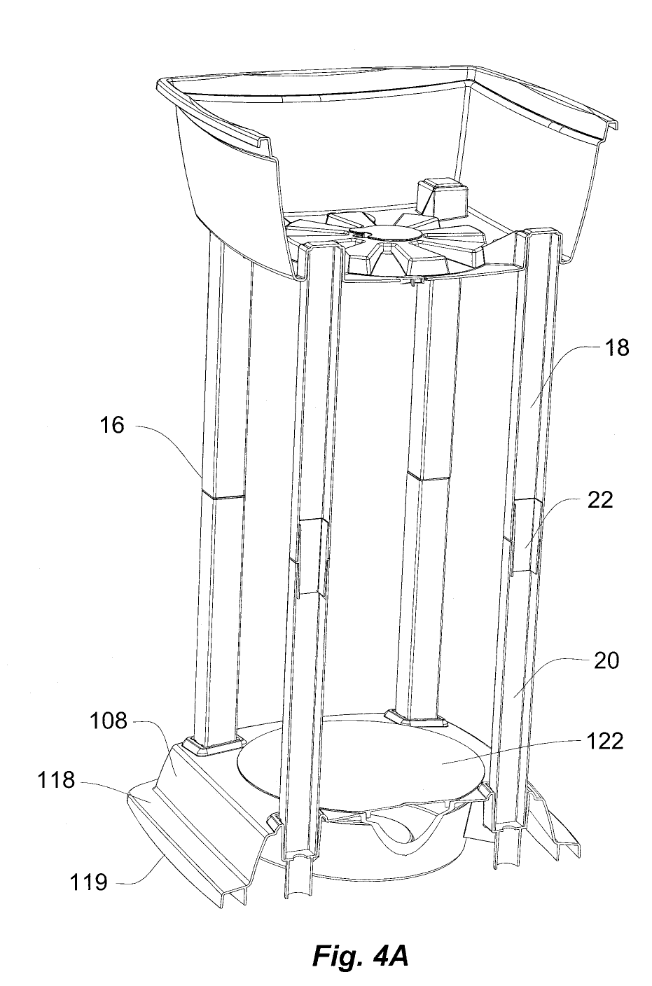

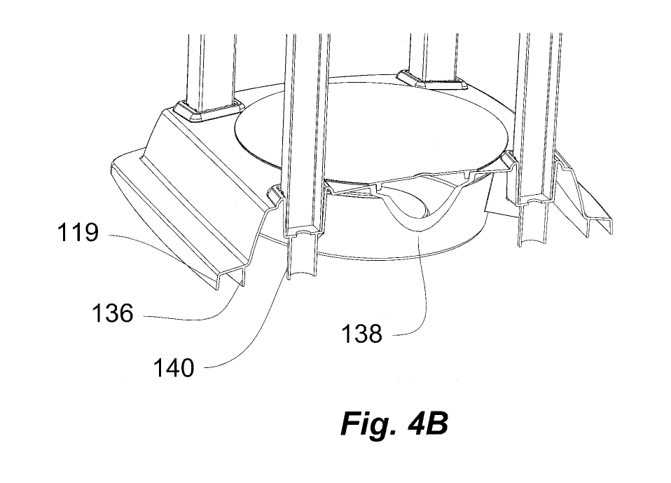

Referring to FIGS. 1-2, the elevated gardening device 10 of the instant invention is illustrated. The elevated gardening device contains a planter bed 12, a support base 14, and support legs 16. FIG. 3 illustrates an exploded view of the elevated gardening device 10 and demonstrates the connection of the planter bed 12 to the support base 14 through the support legs 16. The support legs 16 contain a first end 16a and a second end 16b. As illustrated, the support legs 16 can be made of a plurality of individual support legs, 18 and 20, interconnected through support leg connecting element 22 to make up the larger, main support leg 16. The top portion 24 of support leg 18 is constructed in such a manner to connect through an opening (not illustrated) of the planter bed support leg receiving socket 26 which is located on the bottom surface of the planter bed 12. The bottom portion 28 of support leg 18 is inserted into the top portion 30 of leg connecting element 22. The bottom portion 32 of leg connecting element 22 inserts into the top portion 34 of the support leg 20. The bottom portion 36 of support leg 20 is inserted into the opening 38 of the support base leg receptacle 40. In a preferred embodiment, all support legs are designed to be interchangeable and can press fit into either the planter bed 12 or support base 14, see FIG. 4A. In this manner, the distance between the planter bed 12 and the support base 14, and thus the overall height of the elevated device, can be increased or decreased, thereby providing a planter bed which is at a more convenient height for watering and plant maintenance for a particular individual or environment.

Planter bed 12 is defined by an outer wall 42 made of a front panel 44, a back panel 46, a right side panel 48 and a left side panel 50. Each of the panels 44, 46, 48, and 50 extend upwardly from the perimeter of the bottom panel 52 and partially enclose the top surface 53 of the bottom panel 52. In the preferred embodiment, the planter bed is formed of, but not limited to, a suitable plastic, such as polypropylene, through the process of injection molding. Panels 44, 46, 48, and 50 contain a lipped portion 54 and a depending wall 55. The depending wall 55 extends in an upward direction from the lipped portion and has depending wall edge 56 which defines the upper perimeter of the planter bed 12. The bottom panel 52 contains a center aperture 58 sized to receive the root and/or the stem portions of one or more plant varieties. The bottom panel 52 may also contain one or more side apertures 60. The one or more side apertures 60 are preferably smaller in diameter than the center aperture 58 and may be positioned anywhere within bottom panel 52. Preferably, the planter bed 12 contains four side apertures arranged 90 degrees from the center aperture 58, thereby forming a diamond pattern around center aperture 58. In this arrangement therefore, the planter bed 12 can accommodate one large plant and four smaller plants. Having a large center aperture allows transplanting of more mature plant varieties into the planter bed 12. Covering center aperture 58 and the one or more side apertures 60 are planter bed main cover 62 and one or more planter bed side aperture cover 64.

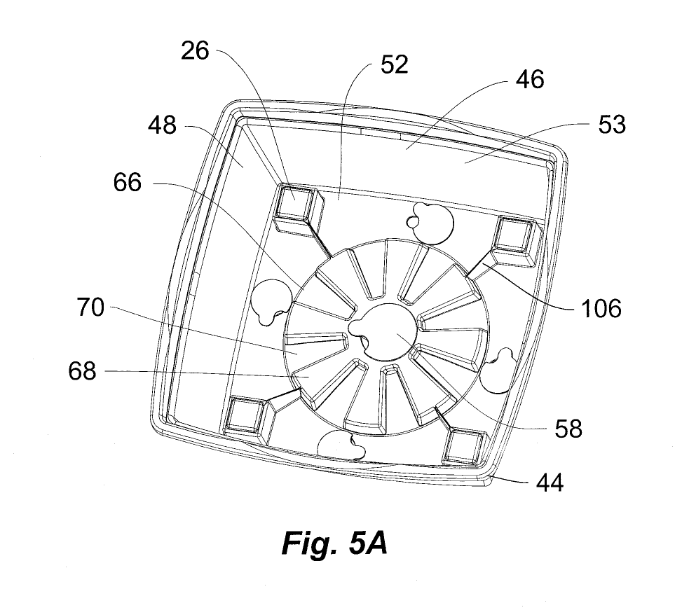

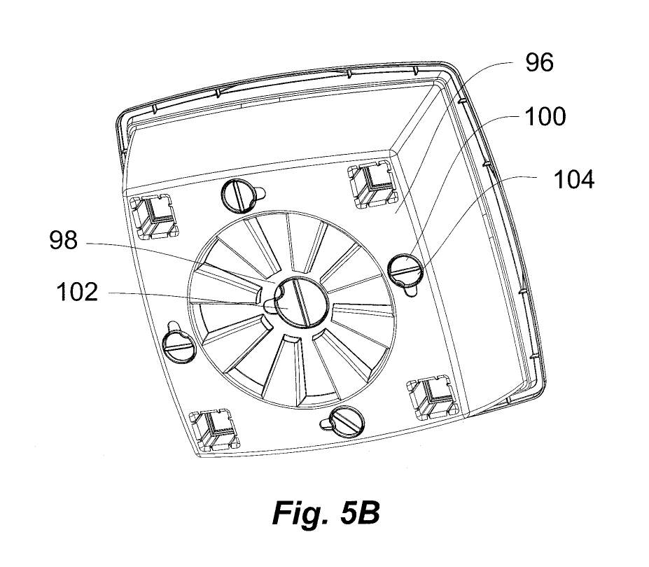

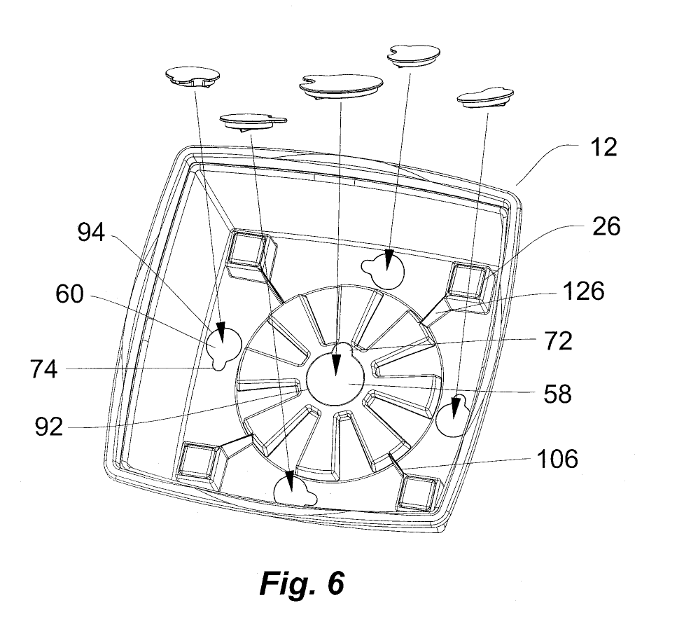

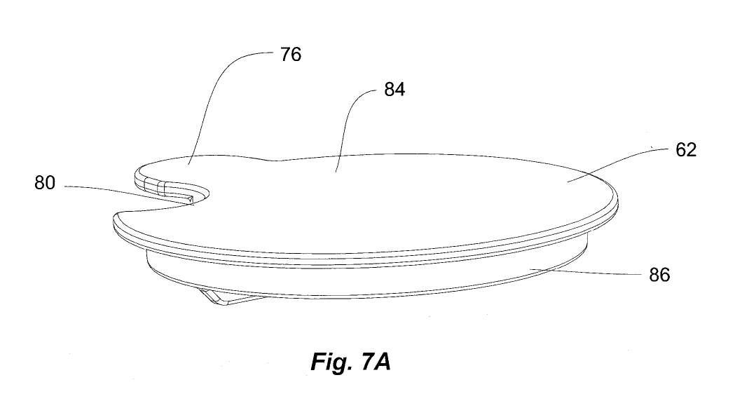

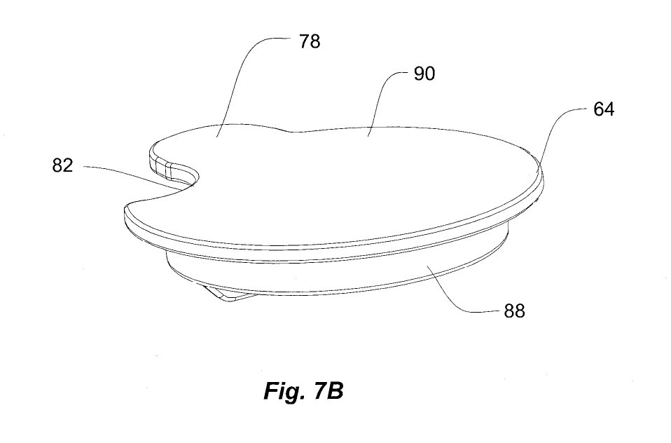

FIG. 5A illustrates the top surface 53 of a particular embodiment of the bottom panel 52 in which the planter bed 12 contains a root holding element 66. The root holding element 66 contains a series of alternating raised surfaces 68 and troughs 70. In a particular embodiment, the alternating raised surfaces 68 and troughs 70 are arranged radially about the center aperture 58. Referring to FIG. 6, the planter bed 12 is illustrated with the front panel 44 having been removed. The center aperture 58 and side aperture 60 are generally circular in shape and include finger-like extension cut outs 72 and 74, respectively, along the perimeter of the generally circularly shaped apertures. Both the center aperture 58 and the one or more planter bed side apertures 60 are constructed and arranged to receive a planter bed main cover 62 and one or more side aperture cover 64. FIGS. 7A and 7B illustrate particular embodiments of the planter bed main cover 62 and the one or more planter bed side aperture cover 64. The planter bed main cover 62 and one or more planter bed side aperture cover 64 can be constructed to mirror the shape and contour of the center aperture 58 and the one or more side apertures 60. In addition to the finger-like extensions 76 and 78, both the planter bed main cover 62 and the one or more planter bed side aperture cover 64 include inwardly curved, or concave, portions 80 and 82, which form a “c” section along the perimeter. Radiating downward from the top surface 84 of the planter bed main cover 62 is a side wall 86.

The one or more planter bed side aperture cover 64 also contains a side wall 88 radiating in a downward direction from the top surface 90. In use, the main planter bed cover 62 and the one or more planter bed side aperture cover 64 are placed within center aperture 58 and the one or more side apertures 60 such that side walls 86 and 88 engage with the ridge 92, see FIG. 6, of the center aperture 58 and ridge 94 of the one or more planter bed side apertures 60. In this configuration, the top surfaces 84 and 90 are flush with the top surface 53 of the bottom panel 52. FIG. 5B illustrates the bottom surface 96 of the bottom panel 52 with the main cover 62 inserted into the center aperture 58 and the one or more planter bed side apertures 64 inserted within the one or more planter bed side apertures 60. Attached to the bottom surface 98 of the main cover 62 and the bottom surface 100 of the side aperture cover 64 are generally rectangular elements 102 and 104. The generally rectangular elements 102 and 104 are illustrated spanning the diameter of the apertures, however, such illustration is not limiting as the generally rectangular elements 102 and 104 may be designed to have a length that covers a portion of the diameter.

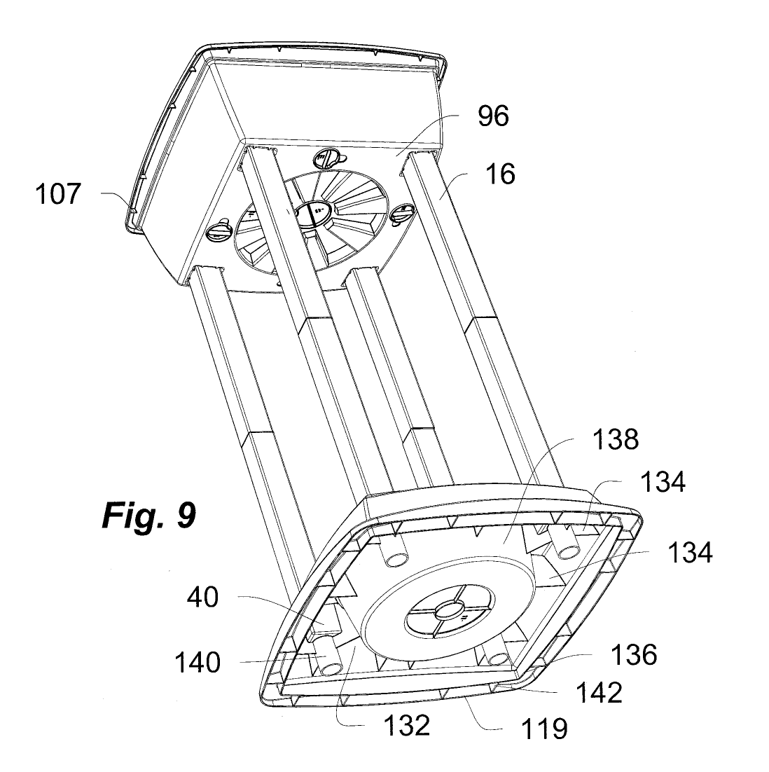

Planter bed 12 includes one or more integrally formed gussets 106 for added strength and rigidity. The gussets 106, increase the structural integrity of the planter bed by preventing the panels 44, 46, 48, and 50 from bowing or bending inwardly or outwardly and thus, adversely affecting the appearance or operation of the planter bed 12. The integrally formed gussets 106 are preferably positioned between the planter bed support leg receiving receptacle 26 and the series of alternating raised surfaces 68 and troughs 70 of the root holding element 66. In addition to gussets 106, the planter bed 12 contains ribs 107, see for example FIG. 9, connecting depending wall edge 56 to depending wall 55 for added structural support. The strengthening ribs 107 are integrally formed within the planter bed 12 in order to enhance rigidity of the components while leaving the external surface in a generally smooth condition for aesthetic purposes.

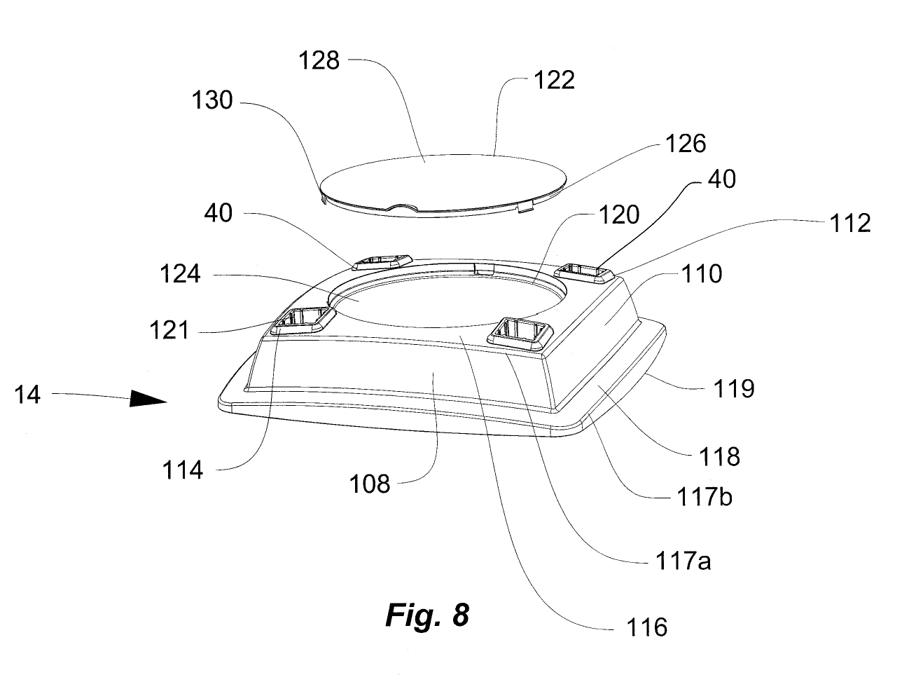

FIG. 8 illustrates a particular embodiment of the support base 14. The support base 14 contains a plurality of integrally formed side walls, 108, 110, 112, and 114. The side walls extend downwardly from a first planer surface 116. Each of the side walls 108, 110, 112, and 114 terminate at a first edge 117a of a second surface 118. A second edge 117b extends by a horizontal distance from the first edge 117a. The distance between the first edge 117a and the second edge 117b defines the second surface 118 and forms a perimeter around the first surface 116. Extending from the second edge 117b is a support base depending wall 119. Positioned within the first planer surface 116 is a plurality of support base leg receptacles 40. The plurality of support base leg receptacles 40 can be located anywhere within the support base 14 but are preferably positioned at each of the four corners of the first planer surface 116. Each of the plurality of support base leg receptacles 40 may contain one or more internal channels, or grooves, 121 which are constructed and arranged for slideable receipt of support legs 16 and help secure the support legs 16 within the support base leg receptacles 40. In order to provide proper alignment, the location of the support base leg receptacles are preferably aligned with the location of the planter bed support leg receiving sockets 26.

Positioned in the center of support base 14 is an internal cavity 120 which is constructed and arranged to receive a support base cover 122. Positioned at or near the top portion of the internal cavity 120 is a ridge 124. The ridge 124 receives the side wall 126 of the support base cover 122 such that when inserted, the surface 128 of the support base cover 122 is flush with the first planer surface 116. While the internal cavity 120 is illustrated as generally circular, such shape is illustrative only and is not limiting in scope. The support base cover 122 may contain a locking member to secure the support base cover to the support base cavity, such as an interlocking tabs 130, which is constructed and arranged to engage with a locking member receiving area, such as the interlocking tab receiving area 132 positioned at or near the ridge 124 of the internal cavity 120, see FIG. 6.

FIG. 9 is a bottom perspective view of a particular embodiment of the instant invention, illustrating the construction and arrangement of the bottom surface 96 of the planter bed 12 and the bottom surface 132 of support base 14. Support base gussets 134 are integrally formed between the inner wall 136, which can be integrally formed and extend from the first edge 117a, and the outer surface 138 of inner cavity 120 or cylindrical body 140. The cylindrical body 140 is attached to the bottom surface of the support base leg receptacles 40. In addition to the gussets, integrally formed support base ribs 142 are formed between the inner wall 136 and the support base depending wall 119.

The integrally formed side walls of the planter box can be designed to taper as they extend upwardly or mirror the shape of the support base side walls. The support base side walls may be designed to taper or mirror the planter bed walls as they extend downward. In these arrangements, the planter bed 12 and support base 14 can be stored in a nested arrangement. When in the nested position, the lipped portion 54 of the planter bed 12 rests at or near position where the plurality of integrally formed side walls of the support base 14 meet the second planar surface 118 such that the depending wall edge 56 of the planter bed 12 is supported by the second planar surface 118.

One of the advantages of the instant invention is that the gardening device is portable, reusable, and can be easily assembled. As such, the instant invention can be sold as a completed unit or as a kit. The kit, for example, could include the individual components of the elevated gardening device, as described previously, including the planter bed, the base support, the plurality of support legs, the support leg connecting elements, and the plurality of covers, including the support base cover, the main cover, and the one or more planter bed side aperture covers of the planter bed.

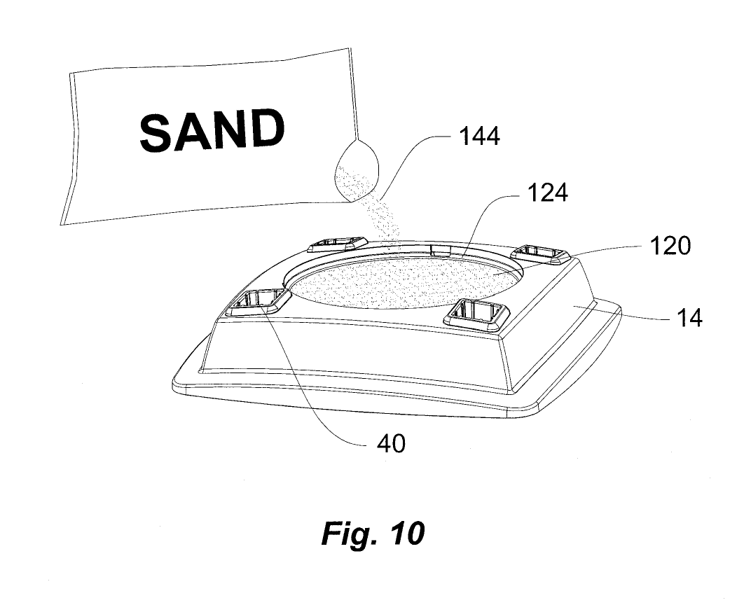

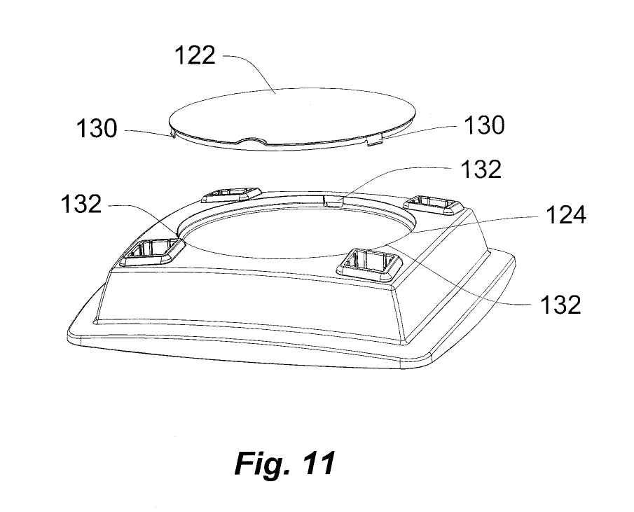

To assemble the elevated gardening device, the support base 14 is positioned at a desirable location, preferably a flat and level surface. In order to provide enhanced stability, a suitable stabilizing material 144, such as sand, dirt, water, or gravel, is inserted into the internal cavity 120 positioned in the center of support base 14, see FIG. 10. Care is taken so as to not fill the plurality of support base leg receptacles 40 with the stabilizing material. Once the internal cavity 120 has been filled to the desired level with the stabilizing material, any excess material located on or near ridge 124 is removed. After removal of the excess material, the support base cover 122 is secured to the support base 14 by placing it over the opening of the internal cavity and aligning the interlocking tabs 130 positioned on or integrally formed within the support base cover 122 with the interlocking tab receiving area 132 positioned at or near the ridge 124 of the internal cavity 120, see FIG. 11. The support base cover 122, therefore, can be secured to the internal cavity 120, such as by snap fitting, thereby securing the contents within the internal cavity 120 and providing a flush surface.

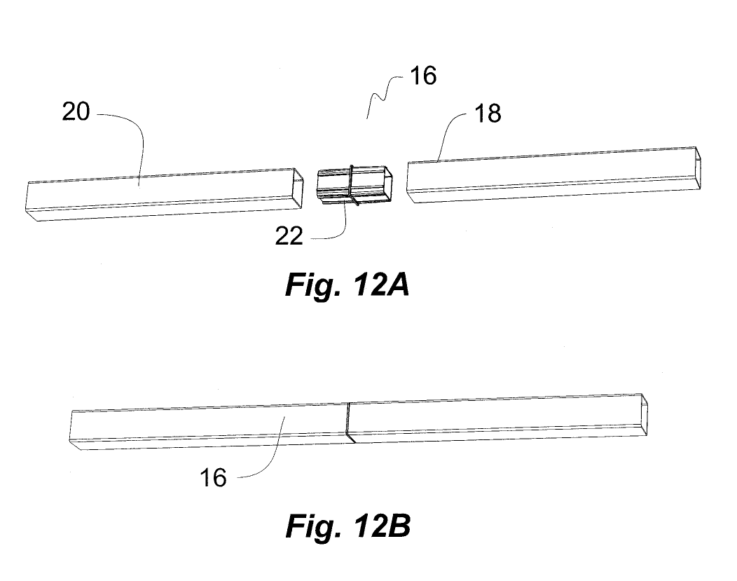

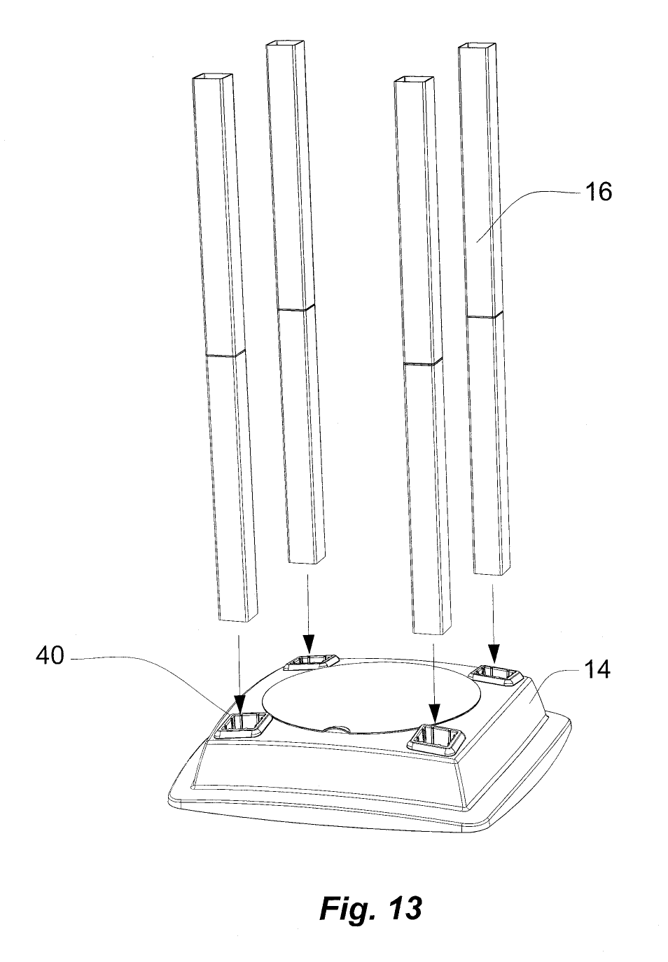

To provide a desired height, the elevated gardening device 10 contains a plurality of support legs 16, preferably four. To achieve a desired height, support legs 16 can be made of several individual support legs 18 and 20, which are interconnected together to form main support leg 16. FIGS. 12a and 12b illustrate the assembly of main support leg 16, utilizing individual legs 18 and 20 and support leg connecting element 22. To assemble, the user simply pushes support leg 18 over one portion of the support leg connecting element 22 and pushes one end of support leg 20 over the opposite portion of the support leg connecting element 22. The user repeats the assembly until all four main support legs 16 are assembled and ready for insertion into the support base 14, see FIG. 13. As illustrated, each of the plurality of support legs 16 are inserted into the plurality of support base leg receptacles 40.

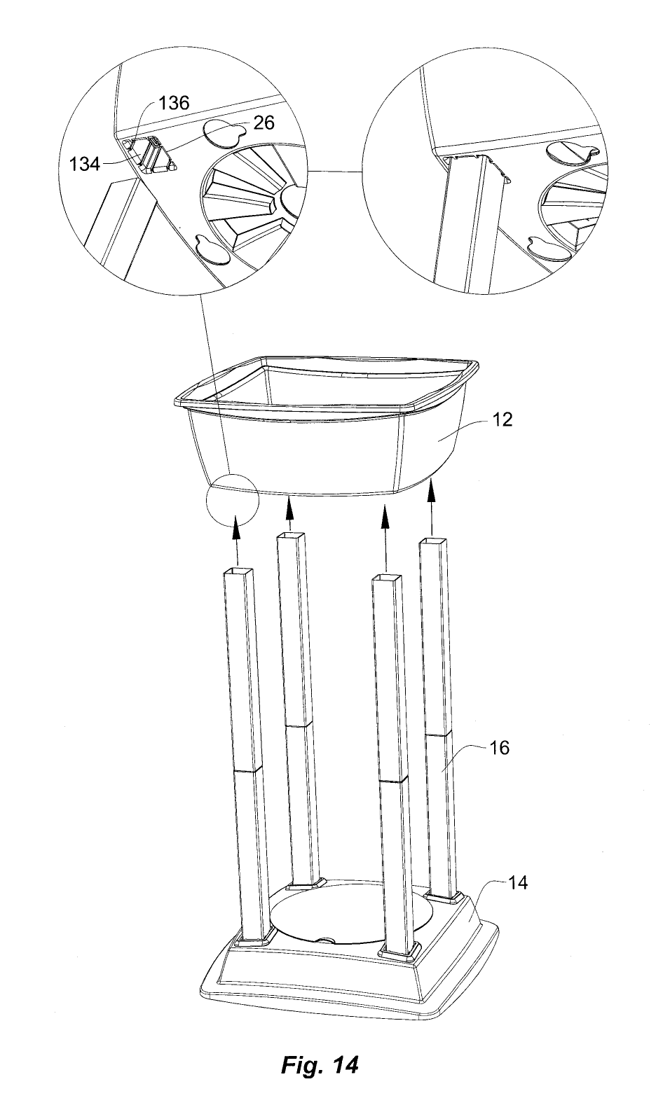

While the plurality of support base leg receptacles 40 can be positioned anywhere along the support base 14, it is preferable that the plurality of support base leg receptacles 40 be positioned at each of the four corners of the support base 14. Such alignment provides a device that is more stable under static load, easier to load and unload the stabilizing material from the base, and provides a more stable device when plants are grown in the center of the planter bed. All four main support legs 16 are constructed to be interchangeable and press fit into the support base 14, or the planter bed 12. After assembly and insertion into the base support 14, main support legs 16 are then inserted into the bottom of planter bed 12, see FIG. 14. Main support legs 16 are press fit into the opening 134 of the planter bed support leg receiving receptacle 26 and secured through 136. Once inserted, the user applies pressure to the top surface 53 of the bottom panel 52 to ensure that each leg is completely inserted into planter bed 12. By adjusting the number of support legs which form the main support leg 16, the height of the planter bed relative to the ground or support base can be manipulated to a desired and more convenient distance for watering and plant maintenance.

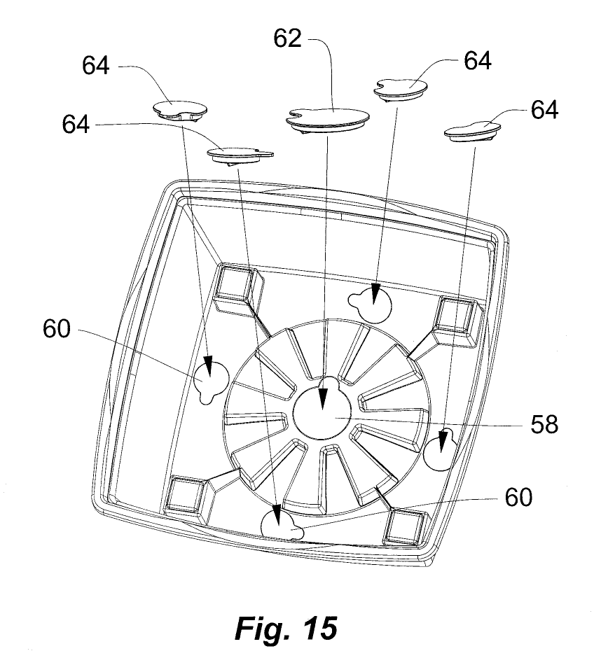

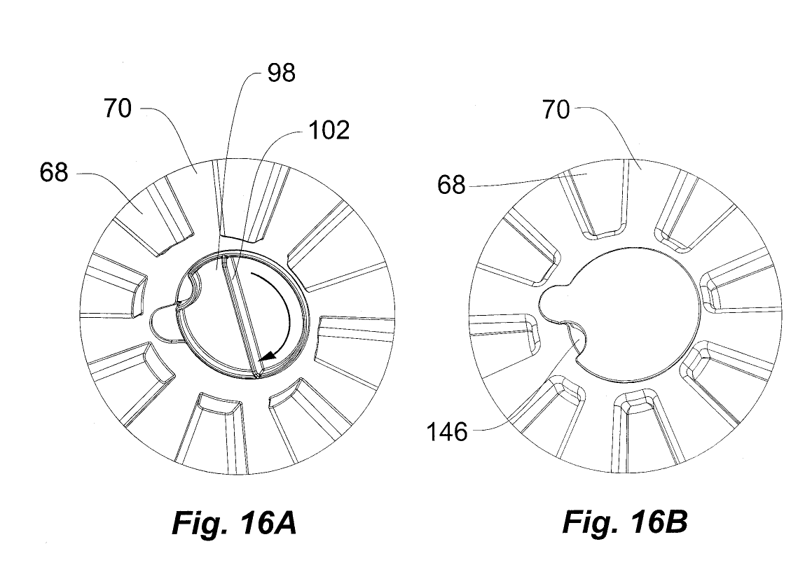

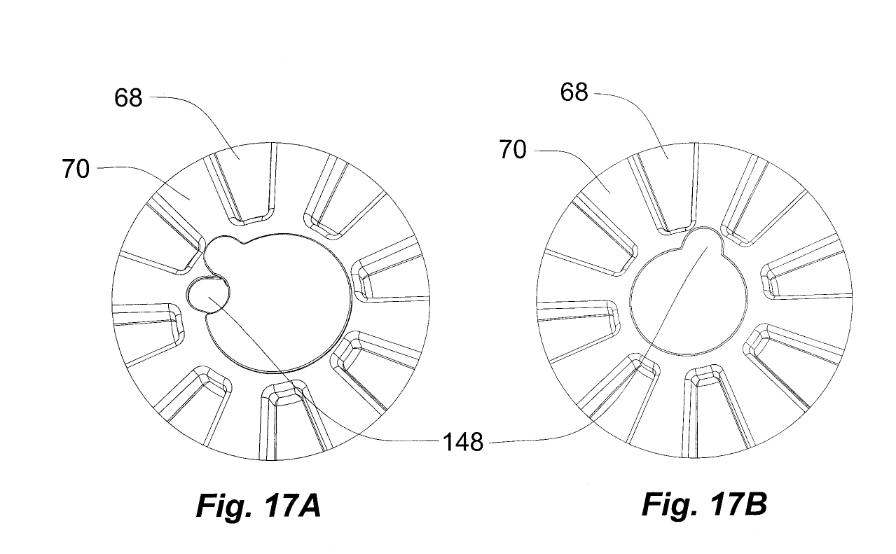

As described previously, the planter bed 12 is constructed to contain center aperture 58 and one or more side apertures 60 sized to receive the root and/or the stem portions of one or more plant varieties. If the user does not use all apertures to grow various plant varieties, apertures 58 and 60 can simply be covered with main cover 62 and the one or more planter bed side aperture cover 64, see FIG. 15. Once inserted, the user, either from the top or bottom of the planter bed 12, turns the main cover 62 and/or the one or more planter bed side aperture cover 64 into position to create a drainage hole 146, see FIGS. 16A and 16B. Once the desired apertures are covered, the user is ready for insertion of plants. For upside down plant growth, the user simply removes the plant from a nursery pot. The plant is turned upside down and inserted up through one of the apertures of the bottom panel 52 of the planter bed 12. While cradling the root ball in one hand, the user moves the plant stem into the finger-like extensions 72 and 74 of center aperture 58 and/or the one or more planter bed side aperture 60. Using the opposite hand, the user can then place main cover 62 and/or the one or more planter bed side aperture cover 64 under the root ball and over the corresponding aperture. While placing the covers over the aperture, the user can also align finger-like extensions 72 and 74 with the inwardly curved concave portions 80 and 82 of main cover 62 and/or one or more planter bed side aperture 64. This alignment creates the opening for a plant stem cut out section 148, see FIG. 17A and FIG. 17B. The root ball can be set down along any portion of the root holding system if desired and the process is repeated with the remaining plants. After all remaining plants have been inserted, the user then fills the planter bed with soil to cover the root balls. To plant a variety of plants for upward growth, the user simply removes the plants from the nursery pot and places them in the planter bed. Plants should preferably be set with the soil line 1 inch below the top of the planter bed and no deeper than the spoil line from the nursery pot. The user can then arrange the plants on top of the soil that was used for the bottom plants. If needed, additional soil can be added to the bottom in order to raise the plants. Both the upward and downward growing plants can be watered and fertilized as necessary, depending on the plant type grown.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A portable and reusable gardening device for providing plant growth in multiple directions comprising:
a planter bed for holding one or more plants, said planter bed including an outer wall defined by a front panel, a back panel, a right side panel, and a left side panel, said panels constructed and arranged to partially enclose a bottom panel, each of said side panels extending upwardly from said bottom panel, said bottom panel having at least one aperture for receipt of a plant root or stem system;
a support base, said support base having integrally formed side walls extending downward from a first generally planer surface and constructed and arranged to enclose an integrally formed inner cavity for receiving stabilizing materials and constructed and arranged to cooperate with a support base internal cavity cover, and a second surface forming a perimeter around said first surface;
a plurality of planter bed support legs for providing support and height to said planter bed, said planter bed support legs having a first end constructed and arranged to be secured to and extending below said planter bed and a second end constructed and arranged to be secured to and extend above said support base;
whereby said planter bed provides growth of one or more plant varieties in a downward manner while simultaneously providing for plant growth in an upward direction.

2. The portable and reusable gardening device for providing plant growth in multiple directions according to claim 1 wherein said bottom panel of said planter bed includes a plurality of integrally formed sockets, each of said plurality of integrally formed sockets constructed and arranged to receive and retain said plurality of planter bed support legs.

3. The portable and reusable gardening device for providing plant growth in multiple directions according to claim 2 wherein said plurality of integrally formed sockets are arranged along the perimeter of said bottom panel of said planter bed.

4. The portable and reusable gardening device for providing plant growth in multiple directions according to claim 2 wherein said support base includes a plurality of integrally formed support base leg receptacles constructed and arranged to receive and retain said plurality of planter bed support legs.

5. The portable and reusable gardening device for providing plant growth in multiple directions according to claim 4 wherein said integrally formed support base leg receptacles are arranged along the perimeter of said support base.

6. The portable and reusable gardening device for providing plant growth in multiple directions according to claim 1 wherein said bottom panel further includes a root holding element, said root holding element having a series of alternating raised surfaces and troughs for supporting a plant variety root system.

7. The portable and reusable gardening device for providing plant growth in multiple directions according to claim 6 wherein said alternating raised surfaces and troughs are arranged radially about said at least one aperture.

8. The portable and reusable gardening device for providing plant growth in multiple directions according to claim 1 wherein said outer wall of said planter bed contains a lipped portion and a depending wall, said depending wall extending in an upward direction from said lipped portion and having a depending wall edge which defines the upper perimeter of said planter bed.

9. The portable and reusable gardening device for providing plant growth in multiple directions according to claim 1 wherein said support base includes a depending wall extending downward from said second surface.

10. The portable and reusable gardening device for providing plant growth in multiple directions according to claim 1 wherein said bottom panel of said planter bed includes a main aperture positioned in the center.

11. The portable and reusable gardening device for providing plant growth in multiple directions according to claim 10 wherein said bottom panel of said planter bed includes one or more side apertures.

12. The portable and reusable gardening device for providing plant growth in multiple directions according to claim 11 wherein said main aperture and said one or more side apertures include finger-like cut out portions extending from the perimeter.

13. The portable and reusable gardening device for providing plant growth in multiple directions according to claim 11 wherein said main aperture has a larger diameter than said one or more side apertures.

14. The portable and reusable gardening device for providing plant growth in multiple directions according to claim 11 wherein said bottom panel of said planter bed includes a planter bed main aperture cover, said planter bed main aperture cover constructed and arranged to cover said main aperture.

15. The portable and reusable gardening device for providing plant growth in multiple directions according to claim 14 wherein said planter bed main aperture cover includes a finger-like extension extending from the perimeter.

16. The portable and reusable gardening device for providing plant growth in multiple directions according to claim 15 wherein said planter bed main aperture cover includes an inwardly curved portion for providing a drainage hole.

17. The portable and reusable gardening device for providing plant growth in multiple directions according to claim 16 wherein said bottom panel of said planter bed includes a main aperture plant stem receiving area, said main aperture plant stem receiving area defined by alignment of said inwardly curved portion of said planter bed main cover with said finger-like cut out extending from the perimeter of said planter bed center aperture.

18. The portable and reusable gardening device for providing plant growth in multiple directions according to claim 11 further includes one or more planter bed side aperture covers, said one or more planter bed side aperture covers constructed and arranged to cover said one or more planter bed side aperture.

19. The portable and reusable gardening device for providing plant growth in multiple directions according to claim 18 wherein said one or more planter bed side aperture cover contains an inwardly curved portion for providing a drainage aperture.

20. The portable and reusable gardening device for providing plant growth in multiple directions according to claim 19 wherein said one or more side planter bed apertures include a finger-like cut out extending from the perimeter.

21. The portable and reusable gardening device for providing plant growth in multiple directions according to claim 20 wherein said bottom panel of said planter bed includes a plant stem receiving area, said plant stem receiving area defined by alignment of said inwardly curved portion of said one or more planter bed side aperture cover with said finger-like cut out extending from the perimeter of said one or more planter bed side aperture.

22. The portable and reusable gardening device for providing plant growth in multiple directions according to claim 1 wherein said support base includes a support base cover constructed and arranged to cooperate with and enclose said internal cavity of said support base.

23. The portable and reusable gardening device for providing plant growth in multiple directions according to claim 1 wherein said support base includes a plurality of strengthening ribs and gussets for adding strength and rigidity to said support base.

24. The portable and reusable gardening device for providing plant growth in multiple directions according to claim 1 wherein said planter bed includes a plurality of strengthening ribs and gussets for adding strength and rigidity to said planter bed.

25. The portable and reusable gardening device for providing plant growth in multiple directions according to claim 1 wherein said panels of said outer wall of said planter bed taper as they extend upwardly and said support base side walls taper as they extend downward, wherein said planter bed and said support base may be stored in a nested arrangement.

26. A portable and reusable gardening device kit comprising:
a planter bed for holding one or more plants which grow in a downward direction while simultaneously holding one or more plants which grow in an upward direction, said planter bed including an integrally formed outer wall defined by a front panel, a back panel, a right side panel, and a left side panel, said panels constructed and arranged to partially enclose a bottom panel, each of said side panels extending upwardly from said bottom panel, said bottom panel having at a main aperture positioned in the center for receipt of a plant root or stem system and one or more side apertures for receipt of a plant root or stem system, said bottom panel having a plurality of integrally formed sockets, each of said plurality of integrally formed sockets constructed and arranged to receive and retain a plurality of planter bed support legs and a root holding element, said root holding element having a series of alternating raised surfaces and troughs for supporting a plant variety root system.
a support base, said support base having integrally formed side walls extending downward from a first generally planer surface and constructed and arranged to enclose a an integrally formed inner cavity for receiving stabilizing materials and constructed and arranged to cooperate with a support base internal cavity cover, and a second surface forming a perimeter around said first surface, said support base having a plurality of integrally formed support base leg receptacles constructed and arranged to receive and retain a plurality of planter bed support legs;
a plurality of planter bed support legs for providing support and height to said planter bed, said planter bed support legs having a first end constructed and arranged to be secured to and extending below said planter bed and a second end constructed and arranged to be secured to and extend above said support base;
a planter bed main aperture cover constructed and arranged to cover said main aperture;
one or more planter bed side aperture cover constructed and arranged to cover said one or more planter bed side aperture; and
a support base cover constructed and arranged to cooperate with and enclose said internal cavity of said support base.

27. The portable and reusable gardening device kit according to claim 26 wherein said plurality of integrally formed sockets are arranged along the perimeter of said bottom panel of said planter bed and said integrally formed support base leg receptacles are arranged along the perimeter of said support base.

28. The portable and reusable gardening device kit according to claim 27 wherein said alternating raised surfaces and troughs are arranged radially about said center aperture.

29. The portable and reusable gardening device kit according to claim 26 wherein said outer wall of said planter bed contains a lipped portion and a depending wall, said depending wall extending in an upward direction from said lipped portion and having a depending wall edge which defines the upper perimeter of the planter bed.

30. The portable and reusable gardening device kit according to claim 26 wherein said support base includes a depending wall extending downward from said second surface.

31. The portable and reusable gardening device kit according to claim 26 wherein said planter bed main aperture cover and said one or more planter bed side aperture covers contain an inwardly curved portion for providing a drainage aperture or a root system receiving area.

32. The portable and reusable gardening device kit according to claim 26 wherein said support base includes a plurality of strengthening ribs and gussets for adding strength and rigidity to said support base.

33. The portable and reusable gardening device kit according to claim 26 wherein said planter bed includes a plurality of strengthening ribs and gussets for adding strength and rigidity to said planter bed.

34. The portable and reusable gardening device kit claim 26 wherein said panels of said outer wall of said planter bed taper as they extend upwardly and said support base side walls extending taper as they extend downward, wherein said planter box and said support base may be stored in a nested arrangement.
